(19) United States
(12) Patent Application Publication
(10) Pub. No.: US 2006/0219130 A1
(43) Pub. Date: Oct. 5, 2006

(54) Water-based extender vehicle composition, and method for tinting and use

(76) Inventors: Cynthia Lou Allison, Cartersville, GA (US); Barry N. Williams, Cedartown, GA (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/391,948

(22) Filed: Mar. 29, 2006

Related U.S. Application Data
(60) Provisional application No. 60/667,163, filed on Mar. 31, 2005.

(51) Int. Cl. C09D 11/00

(52) U.S. Cl. 106/31.41; 106/31.73; 106/31.49; 106/31.78; 106/31.58; 106/31.86; 106/31.43; 106/31.75

(57) ABSTRACT

The present invention relates to the use of esterified tall oil rosin, esterified wood rosin, esterified gum rosin, and mixtures thereof to enhance water-based flexographic ink. The products and methods of the present invention result in enhanced image clarity and resolution; enhanced image clarity and resolution as a result of elimination of most press-side imperfections such as ghosting, inefficient ink transfer and bronzing; increased ink mileage up to three times that of conventional water-based inks; achievement of fine-line details; increased gloss properties on high hold-out liners; and increased color strength and density on most paper and paperboard substrates.

### RELATED APPLICATION

This application claims priority to provisional application Ser. No. 60/667,163 filed Mar. 31, 2005.

### FIELD OF THE INVENTION

There exists a need in the art of flexographic printing for an ink which is inexpensive, non-toxic, non-flammable, non-polluting, and exhibits good properties such as rub and smudge resistance, scuff and scratch resistance, and fast drying. Other favorable ink properties include “true” transparency and high gloss. Common press-side imperfections encountered during the flexographic printing process may include “ghosting,” “inefficient ink transfer,” and “bronzing.” These press-side imperfections equate to costly paperboard waste, production downtime due to frequent wash-ups, and the use of one or more press-side additives, as deemed necessary.

### DESCRIPTION OF RELATED ART

Water-soluble resins (hard resins) have been used widely in the ink and coatings industries. These hard resins exhibit varying properties including softening point, acid number and viscosity.

TABLE 1
Typical Hard Resin Properties

| | | | |
|---|---|---|---|
| | Softening | | |
| Product Name | Point (° C.) | Acid Number | Viscosity |

Arizona Chemical Company

| | | | |
|---|---|---|---|
| 8112 | 124 | 114 | K^{(a)} |
| 8190 | 151 | 186 | F^{(a)} |
| 8195 | 152 | 195 | G^{(a)} |

MeadwestVaco Specialty Products Group

| | | | |
|---|---|---|---|
| SM-700 | 124 | 120 | 250^{(b)} |
| SM-705 | 150 | 195 | 225^{(b)} |

Akzo Nobel Resins

| | | | |
|---|---|---|---|
| Filtrez 525 | 140 | 115 | S^{(a)} |
| Filtrez 526 | 125 | 125 | F^{(a)} |
| Filtrez 567 | 130 | 175 | E^{(a)} |
| Filtrez 5014 | 140 | 170 | N^{(a)} |

Notes:
^{(a)}= 60% in Anhydrous Ethanol, 25° C. Gardner
^{(b)}= 35% Solution, cPs (250 C.)

Other resin properties that may be considered by the user are water and chemical resistance.

With the onset of acrylic polymers over 30 years ago, the use of these hard resins in the printing industry has declined. Current day polymer chemistry is turning its attention from standard acrylic polymers to pH- and viscosity-stable acrylic emulsions for use in the printing industry. However, over the past few years the cost of acrylic polymers has in some instances almost doubled making them cost prohibitive, particularly in the printing ink industry where profit margins are already minimal at best.

In some market segments, the addition of solutions comprised of hard resins to acrylic polymer formulations to enhance the performance of acrylic polymers is being sought in an attempt to reduce the cost of using acrylic polymers. This invention supports the use of specific primary hard resins, and/or secondary or co-resins in an extender vehicle composition that increases the transferability and gloss properties of water-based overprint varnishes (OPVs) and printing inks on high hold-out liner and other paper substrates, and eliminates most press-side imperfections.

### SUMMARY OF THE INVENTION

The present invention relates to esterified tall oil rosin, esterified wood rosin, esterified gum rosin, and mixtures thereof. Esterified tall oil rosin is produced as a secondary by-product from the pulp and paper process, and is usually recovered from pine wood “black liquor” of the sulfate or kraft paper process. Esterified wood rosin is produced from Southern pine stumps. Esterified gum rosin is a primary product from the production of turpentine. Gum rosin is a more pure form of tall oil or wood rosin in that the sulfur content and other impurities have been removed by additional refinery processing.

More specifically, this invention relates to methods of using fumarated rosin esters (historically, referred to as water-soluble maleic rosin esters) in preparing a water-based extender vehicle, a water-based high-gloss varnish, and water-based flexographic ink compositions which significantly reduce or eliminate most press-side imperfections encountered in the paper and paperboard industry. This invention provides a method for camouflaging the extender vehicle by tinting (color coding) to allow the user to distinguish between various varnish formulations by color. This invention also provides for a high hold-out liner formulation for kraft stock using a variation of the extender vehicle composition. It should be noted that the terms “extender vehicle” and “varnish” are used interchangeably in this document.

Common press-side imperfections encountered during the flexographic printing process include “ghosting,” “inefficient ink transfer,” and “bronzing.” The present invention not only overcomes these common press-side imperfections, but also provides other favorable attributes to the printing ink industry.

The “Ghosting” Imperfection

“Ghosting” provides an appearance on a printed surface such as a silhouette of an image, or a shadow. “Ghosting” usually appears more notably where two or more colors are trapped. Printing ink containing dark pigment frequently “ghost” due to the hydrophilic tendencies of the pigment to absorb moisture from the air. Atmospheric conditions, such as an increase in relative humidity, optimize “ghosting” to occur on printed paper and paperboard surfaces.

Conventional knowledge dictates that “ghosting” occurs because the printing ink requires more drying time. As a result, the speed of a printing press is typically reduced to allow more time for the printing ink to dry. Contrary to conventional knowledge, “ghosting” is a function of the inefficient ink transfer from the anilox cell to the plate to the substrate.

The absence of the “ghosting” appearance on the surface of the inks containing the fumarated resin of the invention is a significant advantage of the invention. As a result, with the addition of the extender vehicle to an OPV or ink formulation, the occurrence of “ghosting” is significantly reduced. More importantly, printing press production rates have been demonstrated to increase by as much as 65 percent.

The “Inefficient Ink Transfer” Imperfection

The increase in the tack, or “snap,” of the ink out of the anilox cell, should provide a kiss impression, just enough to provide a dot image on the paper or paperboard surface. This increase in the tack optimizes conditions allowing for the complete transfer of ink to the substrate and provides a perfect dot structure. As a result, dot gain, a defect in which dots print larger than they should causing darker tones or stronger color, is minimized.

With the claim that ink transferability is increased,

The Cyan transferability to kraft stock of the water-based flexographic ink composition is increased by at least 8% as measured by a densitometer.
The Yellow transferability to kraft stock of the water-based flexographic ink composition is increased by at least 50% as measured by a densitometer.
The Magenta transferability to kraft stock of the water-based flexographic ink composition is increased by at least 28% as measured by a densitometer.

The transferability of ink on high hold-out liners, such as kemi-lite, is increased even more dramatically than that demonstrated on kraft stock. High hold-out liner paper has low ink absorption tendencies which allow ink to sit on the surface of the substrate, and the gloss properties are enhanced. As a result, color density and strength are increased because the ink is not absorbed into the paper stock. This increase in color density and strength provided by the extender vehicle formulation system provides for improved image clarity and enhanced resolution on the printed surface. Due to the absorption properties of kraft stock, gloss properties of the extender vehicle composition are not enhanced.

The “Bronzing” Imperfection

The absence of the “bronze” appearance on the surface of the inks containing the fumarated resin of the invention is a significant advantage of the invention. Surface bronze appearance on printed surfaces appears to slightly change color as the angle of viewing and illumination changes. Bronzing is a function of pigment particles not being well coated by the ink vehicle (poor pigment wetting). Bronze appearance on the printed surface increases as the concentration of pigment (pigment loading) increases in the ink and usually appears more notably where two or more colors are trapped. Since the extender vehicle formulation allows for a reduction in pigment loading and the wetting properties of the extender vehicle composition system are improved, the tendency for “bronzing” to occur is reduced or eliminated altogether by virtue of visual observation.

Other Invention Attributes

Other extender vehicle composition attributes of this invention include: 1) the inherent ability of the formulation to increase ink mileage; and 2) fine-line details may now be achieved in the water-based flexo corrugated board, and possibly in other paper and paperboard industries.

Increased Ink Mileage

Another significant advantage of this invention is the increase in ink mileage achieved over conventional printing inks. The extender vehicle system is a better transfer agent because it improves image clarity and enhances resolution. That is, more paper stock may be printed using the same quantity of printing ink comprised of the extender vehicle composition than using current day ink technology. Studies have shown that printing inks comprised of the extender vehicle composition provide approximately three times the color density and strength of conventional printing inks as compared to the Pantone Matching System (PMS). This attribute alone equates to significant cost savings to ink manufacturers and printing companies in the corrugated board industry, and possibly, in other paper and paperboard industries.

Achieve Fine-Line Details

Products printed by flexography are known to be well suited for printing large areas of solid color with high gloss and brilliance. A significant advantage of this invention is the ability to print fine-line details with enhanced image clarity and resolution. Conventional knowledge dictates that the use of a fine-line anilox (e.g., 500-line, 700-line and 1,000-line) in the water-based flexo corrugated board industry is difficult because of the inability to transfer a sufficient quantity of ink from the anilox cell to the plate and to the substrate using current day technology.

Contrary to conventional knowledge, the extender vehicle composition of this invention will allow for comparable ink transfer using a 220-line anilox as well as a 500-line anilox. This extender vehicle composition system provides the ink transfer capability, and improved image clarity and resolution in the corrugated board industry to advance current technology into the pre-print and label market industries.

### DETAILED DESCRIPTION OF THE PREFERRED EMBODIMENT

Extender Vehicle Composition

The primary hard resins used in the extender vehicle composition include those having acid numbers ranging from 114 to 195, and a softening point ranging from 124° C. to 152° C. Resins that may be used as a primary resin in extender vehicle formulations according to the invention include, but are not limited to fumarated rosin esters (#1) such as SYLVAPRINT® 8190 or SYLVAPRINT® 8195, which are available from Arizona Chemical Company, Savannah, Ga., or JONREZ® SM-700 or SM-705, which are available from MeadWestvaco, Deridder, La. Gum resins which may also be used as a primary resin include Filtrez 525, Filtrez 526, Filtrez 567, Filtrez 567 or Filtrez 5014. These gum resins are available from Akzo Nobel Resins, Baxley, Ga. Ammonia hydroxide is available from Ashland Chemical Inc., Atlanta, Ga. Isopropyl alcohol is available from Alchem Chemical, Atlanta, Ga. The biocides of choice may include Biochek 721M, Biochek 410, or Biochek 430 available from Bayer Chemicals, Pittsburg, Pa.

In one embodiment of the present invention, the water-soluble extender vehicle composition is comprised of the following:

### Example 1

### Extender Vehicle Composition

| CHEMICALS | CONCENTRATION (wt %) |
|---|---|
| Fumarated Rosin Ester #1 | 32 |
| 28% Ammonia Hydroxide | 15 |
| Isopropyl Alcohol | 15 |
| Water | 37.7 |
| Biocide | 0.3 |

Note:
wt % = weight percent.
The primary fumarated rosin ester component of the extender vehicle may be selected from mid to high viscosity resins, most of which have good ink transfer and gloss properties.

The extender vehicle composition is formulated by premixing the water and a neutralizing agent (ammonia hydroxide) in a vessel. The water and neutralizing agent mixture is then heated to 60° C. Gradually, the resin is added to the mixture using agitation or a mixer to achieve rapid dissolution (20 to 30 minutes). The isopropyl alcohol is next added to the admixture to lower the final viscosity for the intended use, and to obtain the desired drying time. Because of the chemical nature of water-soluble rosin esters, a biocide additive is strongly recommended to inhibit the potential for bacterial growth. However, it is not necessary to achieve the results of the present invention.

This extender vehicle composition may be used as an OPV on high hold-out liners. The natural gloss of the fumarated rosin esters provides for an excellent gloss level on a printed surface, which in some cases has exhibited gloss levels comparable to those provided by ultraviolet (UV)-curable, water-based varnishes that are commercially available today.

This extender vehicle composition may also be used as a press-side additive to printing ink to eliminate common press-side imperfections discussed in the above sections. Press-side demonstrations indicate that the addition of 5 weight percent (wt %) to 20 wt % of the extender vehicle composition to commercially-available water-based flexo printing ink significantly improves, if not totally eliminates, most common press-side imperfections, previously discussed herein.

High-Gloss Varnish Composition

A secondary or co-resin component may be included in the extender vehicle formulation of this invention to improve vehicle gloss on high hold-out liners and transfer properties for most paper and paperboard substrates. The secondary or co-resin component (Fumarated Rosin Ester #2) of the extender vehicle may be selected from higher viscosity hard resins. The secondary or co-resins have lower acid numbers and softening points ranging from 114 to 115, and 124° C. to 140° C., respectively. Conventional knowledge and market research studies indicate that the higher viscosity resins, such as SYLVAPRINT® 8112 [viscosity 275 cps (36 secs #3 Zahn cup)], are not favorable resins for most printing ink applications.

Resins that may be used as a secondary or co-resin in extender vehicle compositions according to this invention include, but are not limited to Fumarated Rosin Esters (#2), such as SYLVAPRINT® 8112, which is available from Arizona Chemical Company, Savannah, Ga., or JONREZ® SM-700, which is available from MeadWestvaco, Deridder, La.

A high-gloss varnish composition using a secondary or co-resin component is comprised of the following:

### Example 2

### High-gloss Varnish Composition

| CHEMICALS | CONCENTRATION (wt %) |
|---|---|
| Fumarated Rosin Ester #1 | 25 |
| Fumarated Rosin Ester #2 | 75 |

The high-gloss varnish composition may be formulated following the same protocol as described under Example 1: Extender Vehicle Composition. Due to the higher viscosity resins (Fumarated Rosin Ester #2), solubility may vary allowing the final percentage of resin to range from 28 to 32 percent. The gloss properties of the varnish composition may range from 74 to more than 90 degrees, depending on the fumarated rosin esters selected and their corresponding combined percentages with one or more primary resins.

Method for Tinting

A method for tinting, or camouflaging, the extender vehicle composition is also a part of this invention. A significant advantage of this invention is to allow the user, including a press-side operator, to identify the extender vehicle formulation by visual observation of color tint. The addition of special-effect or pearlescent pigments provides the user the ability to color tint various extender vehicle compositions.

Special-effect and pearlescent pigments may be mica-based titanium dioxide or glass-flake in composition. Special-effect, or pearlescent pigments may be added to the extender vehicle formulation at a concentration ranging from 0.1 wt % to 5.0 wt %. Care must be taken to incorporate the dry particles into the extender vehicle formulation using a slow mixer or baffled stirring rod so as to not impair the structural integrity or coating of the particles.

| CHEMICALS | CONCENTRATION (wt %) |
|---|---|
| Extender Vehicle Formulation | 99.5 |
| 235 Rutile Green Pearl (10 μm to | 0.5 |
| 60 μm particle size) | |

| CHEMICALS | CONCENTRATION (wt %) |
|---|---|
| Extender Vehicle Formulation | 99.5 |
| 221 Fine Satin Blue (5 μm to | 0.5 |
| 25 μm particle size) | |

| CHEMICALS | CONCENTRATION (wt %) |
|---|---|
| Extender Vehicle Formulation | 99.5 |
| 215 Rutile Red Pearl (10 μm to | 0.5 |
| 60 μm particle size) | |

A second means of providing a color tint to the extender vehicle formulations is by the addition of a bismuth oxychloride solution or paste. Bismuth oxychloride is a synthetic crystal composition (5 μm to 15 μm) grown under laboratory conditions. Bismuth oxychloride provides a tint to the extender vehicle formulation similar to the pearlescent appearance of an abalone shell.

### Example 6

### High-Gloss Varnish-Bismuth Oxychloride Tint

| CHEMICALS | CONCENTRATION (wt %) |
|---|---|
| Extender Vehicle Formulation | 99.9 |
| Bismuth Oxychloride Solution | 0.1 |
| (5 μm to 15 μm particle size) | |

Note:
The concentration of bismuth oxychloride is dependant on the visual effect desired by the user. Bismuth oxychloride is available from EMD Chemicals, Inc., Savannah, Georgia, (Bi Flair 83/835S), and from Engelhard Corporation, Poughkeepsie, New York (Merlin UWA Paste).

Due of the viscous nature, or body, of the extender vehicle formulation, the pearlescent pigments are dispersed uniformly throughout the formulation and remain suspended with minimal settling. A sufficient percent weight of the tinting agent is an important factor in this invention to provide a slight color tint to the extender vehicle, without having the particle size or the particle loading so large that the printed surface is distorted or color tinted.

Method of Use—Ink Composition

Conventional knowledge dictates that a 25- to 50-percent pigment base load may be required to achieve a good quality transparent printing ink in water-based flexography. Contrary to conventional knowledge, a “true” transparent ink will have minimal pigment loading with excellent letdown properties to not conceal the color beneath, and to provide a thinner layer of ink with a smooth transparent surface. In turn, less pigment loading will result in a more transparent printing ink.

Because of the excellent transfer properties of the extender vehicle composition of this invention, a significant reduction in pigment base load can be used to achieve comparable color strength as compared to the PMS. Several examples are discussed in the following paragraphs.

As an example, Ink Composition A (Sweet n Low—Light Pink) was formulated using 92 percent of the extender vehicle composition and a 3 percent pigment base load. Conventional ink formulation practices typically require a 30 to 35 percent pigment base load. In this instance, a significant reduction in pigment loading (as much as an order in magnitude less) was used to formulate a water-based ink composition with enhanced transferability and gloss properties. Because of the increased color strength and enhanced transferability of the printing ink, a reduced pigment base load was required which resulted in a more “true” transparent printing ink having a faster drying time.

The following are examples of high hold-out liner formulations using the extender vehicle composition:

| CHEMICALS | CONCENTRATION (wt %) |
|---|---|
| Extender Vehicle Composition #1 | 92 |
| Base (Sweet-n-Low Light Pink) | 3 |
| Slip Compound | 3 |
| Isopropyl Alcohol | 2 |

| CHEMICALS | CONCENTRATION (wt %) |
|---|---|
| Extender Vehicle Composition #1 | 85 |
| Base (Sweet-n-Low Light Pink) | 10 |
| Slip Compound | 3 |
| Isopropyl Alcohol | 2 |

| | CONCENTRATION |
|---|---|
| CHEMICALS | (wt %) |
| Extender Vehicle Composition #1 | 72 |
| Red Rubine Base (Sweet & Low Dark Red) | 17 |
| Yellow (FR) Base (Sweet & Low Dark Red) | 5 |
| Slip Compound | 3 |
| Isopropyl Alcohol | 3 |

| | CONCENTRATION |
|---|---|
| CHEMICALS | (wt %) |
| Extender Vehicle Composition #1 | 64 |
| Reflex Blue Base (Sweet & Low Dark Blue) | 15 |
| Phthalo Blue Base (Sweet & Low Dark Blue) | 15 |
| Slip Compound | 3 |
| Isopropyl Alcohol | 2 |

The extender vehicle composition used in water-based printing inks may be formulated following the same protocol as described under Example 1: Extender Vehicle Composition. The pH and viscosity of the extender vehicle formulation may be adjusted using water, isopropyl alcohol, or dimethylethanolamine (DMEA). It is important to note that the slip compound must be dispersed extremely well during ink formulation, preferably at the end of the formulation process, to maximize the efficiency of the slip compound and the gloss properties.

Method of Use—Black Ink

The color black (carbon black) is the most widely used pigment in the printing ink industry today. The color “black” is used in printing large background areas on various surfaces, lettering on brown boxes, newspapers, periodicals, books and millions of other sources. As such, the formulation of a “universal black” printing ink that is cost effective with enhanced transferability and gloss properties would provide a significant contribution to the printing ink industry.

The following are examples of black ink formulations using the extender vehicle composition:

### Example 11C

### Matte Finish Black

| | CONCENTRATION |
|---|---|
| CHEMICALS | (wt %) |
| Extender Vehicle Composition #2 | 54 |
| Black Dispersion (Ajack Black B930) | 40 |
| Slip Compound | 3 |
| Isopropyl Alcohol | 3 |

| | CONCENTRATION |
|---|---|
| CHEMICALS | (wt %) |
| Extender Vehicle Composition #2 | 54 |
| Black Dispersion (Ajack Black 36) | 40 |
| Slip Compound | 3 |
| Isopropyl Alcohol | 3 |

| | CONCENTRATION |
|---|---|
| CHEMICALS | (wt %) |
| Extender Vehicle Composition #2 | 54 |
| Black Dispersion (Ajack Black 36CC) | 40 |
| Slip Compound | 3 |
| Isopropyl Alcohol | 3 |

Approximately 15 years ago, the newspaper industry began using water-based flexographic ink technology. The attractiveness of using water-based inks in the newspaper industry is that they are relatively smudge resistant when dry. However, in recent years the newspaper industry reportedly has limited the use of water-based flexographic ink because of transferability issues. Because of the enhanced transferability provided by the extender vehicle formulation of this invention, applications to enhance the use in the water-based flexographic ink in the newspaper industry may exist.

Method of Use—High Hold-Out White

A white printing ink exhibiting high hold-out properties for application to kraft stock is also part of this invention. This high hold-out property provides for a smoother printing surface with less imperfections on kraft stock by filling in paper crevasses and lessening the image of striations on corrugated board. This high hold-out white composition is formulated to be used as a “first-down” before application of any process color or spot color on paper substrates. This high hold-out white composition provides the opacity, brightness, and improved gloss attributable to the extender vehicle formulation, as part of this invention, to enhance any color clarity and image resolution printed on kraft stock.

The following is an example of a high hold-out white formulation using the extender vehicle composition:

### Example 12

### High Hold-out White

| | CONCENTRATION |
|---|---|
| CHEMICALS | (wt %) |
| Extender Vehicle Composition #2 | 70 |
| Titanium Dioxide RDI-S | 20 |
| Slip Compound | 3 |
| Isopropyl Alcohol | 3 |
| Water | 4 |

Note:
The extender vehicle composition is that presented as part of this invention.
Titanium dioxide RDI-S is used in this formulation for opacity and brightness. Titanium dioxide RDI-S is available from Kemira Chemicals, Inc., Kennesaw, Georgia.

In Summary

The extender vehicle composition of the present invention results in enhanced printing capabilities. This is a result of the high molecular affinity of the hard resin vehicles to corrugated board and other paper substrates. Because of this molecular affinity, the adhesion and ink transfer properties of hard resins to paper substrates outperform most current day ink technology, including acrylic polymer emulsions used in the water-based flexography industries. This invention provides numerous benefits to the water-based flexographic printing industry, including:
enhanced image clarity and resolution;
enhanced image clarity and resolution as a result of elimination of most press-side imperfections such as ghosting, inefficient ink transfer and bronzing;
increased ink mileage up to three times that of conventional water-based printing inks;
achievement of fine-line details;
increased gloss properties on high hold-out liners; and
increased color strength and density on most paper and paperboard substrates.

This phenomena is analogous to a dying tree (paper substrate) taking up water (water-soluble resin). The water uptake of a dying tree is phenomenal in an attempt to revive itself and sustain life. Paper substrates recognize their molecular family, and have an affinity for hard resins which allows for a more efficient ink transfer and enhanced gloss properties of water-based printing inks comprised of the extender vehicle formulation for corrugated board and other paper substrates.

The foregoing description of certain embodiments of the present invention has been provided for purposes of illustration only, and it is understood that numerous modifications and alterations may be made without departing from the spirit and scope of the invention.

What is claimed is:

1. A composition for use as a flexographic water-based ink vehicle, ink additive or printing ink comprising:
(a) two or more rosins, the rosins being selected from the group consisting of tree rosins, tall oil rosins, gum rosins, wood rosins, and esters and salts thereof,
wherein the rosins comprise:
i) about 3 to about 40 wt. % of a fumaric modified rosin or resin; and
ii) about 15 to about 70 wt. % of a maleic modified rosin or resin.

2. The composition of claim 1, wherein the fumaric modified rosin or resin is an ester or ester salt thereof, and the maleic modified rosin or resin is an ester or ester salt thereof.

3. The composition of claim 1, further comprising a water soluble solvent.

4. The composition of claim 3, wherein the water soluble solvent is water present in about 25% to about 75% by weight of the composition.

5. The composition of claim 4, wherein the water soluble solvent further includes a pyrrolidone.

6. The composition of claim 5, wherein the pyrrolidone is a n-methyl pyrrolidone in the range of about 1 to about 5 wt. % of the composition.

7. The composition of claim 3, further comprising of anti-foaming agent.

8. The composition of claim 3, wherein the maleic modified rosin is a maleic modified rosin ester salt and the fumaric modified rosin is a fumaric modified rosin ester salt.

9. The composition of claim 8, wherein the salts are ammonium salts.

10. The composition of claim 4, further comprising about 3% to about 20% by weight of a solution of about 28% to about 30% by weight of ammonia.

11. The composition of claim 8, wherein the fumaric modified rosin ester salt is a fumaric modified ester of tall oil rosin.

12. The composition of claim 1, further comprising a colorant.

13. The composition of claim 1, wherein the modified rosins or resins are complexed with a cation to form salts.

14. The composition of claim 13, wherein the cation is selected from the group consisting of amines, ammonium ions and alkyl ammonium ions.

15. The composition of claim 14, wherein the amines are either ethanolamine or diethanolamine or both.

16. The composition of claim 3, further including an organic solvent.

17. The composition of claim 16, wherein the organic solvent is selected from the group consisting of pyrrolidones, alcohols and nitrites.

18. The composition of claim 17, wherein the pyrrolidones are alkyl substituted pyrrolidones.

19. The composition of claim 17, wherein the alcohols are primary aliphatic alcohols, ether alcohols and amino alcohols.

20. The composition of claim 17, wherein the nitrites are acetonitrile and oxydipropionitrile.

21. The composition of claim 16, wherein the organic solvent is anhydrous alcohol present in about 5% to about 12% by weight of the composition.

22. The composition of claim 10, further comprising a base present in about 1% to about 12% by weight of the composition.

23. The composition of claim 22, wherein the base is selected from the group consisting of water-soluble amines, and alkali and alkali earth metal hydroxides.

24. The composition of claim 22, wherein the base is dimethylethanolamine.

25. The composition of claim 1 for use as a flexographic ink additive, further comprising a cation present in about 5% to about 12% by weight of the composition and a water soluble solvent.

26. The composition of claim 25, wherein the cation is a solution of about 28% to about 30% by weight of ammonia, and the water soluble solvent includes water present in about 25% to 75% by weight of the composition.

27. The composition of claim 26, wherein the rosins are rosin or resin esters.

28. The composition of claim 1 for use as a flexographic ink vehicle, further comprising a cation present in about 5% to about 12% by weight of the composition, a base present in about 1% to about 12% by weight of the composition, and a water soluble solvent.

29. The composition of claim 28, wherein the cation is a solution of about 28% to about 30% by weight of ammonia, the base is dimethylethanolamine, and the water soluble solvent includes water present in about 25% to about 75% by weight of the composition.

30. The composition of claim 28, wherein the rosins are rosin or resin esters.

31. The composition of claim 1 for use as a flexographic printing ink, further comprising a cation present in about 5% to about 12% by weight of the composition, a base present in about 1% to about 12% by weight of the composition, a water soluble solvent, and a colorant.

32. The composition of claim 31, wherein the cation is a solution of about 28% to about 30% by weight of ammonia, the base is dimethylethanolamine, and the water soluble solvent includes water present in about 25% to about 75% by weight of the composition.

33. The composition of claim 31, wherein the rosins are rosin or resin esters.

34. The composition of claim 3, wherein the pH of the composition is adjusted to be in the range of about 8 to about 10.

35. The composition of claim 1, further including one or more of a water-soluble or water-dispersible thickener, a wax emulsion, a biocide, a corrosion inhibitor, or a surfactant.

36. A method of producing a composition for use as a flexographic water-based ink vehicle, ink additive or printing ink comprising admixing
(a) two or more rosins, the rosins being selected from the group consisting of tree rosins, tall oil rosins, gum rosins, wood rosins, and esters and salts thereof,
wherein the rosins comprise:
(i) about 3 to about 40 wt. % of a fumaric modified rosin or resin; and
(ii) about 15 to about 70 wt. % of a maleic modified rosin or resin.

37. The method of claim 36, wherein the fumaric modified rosin or resin is a fumaric modified rosin or resin ester or ester salt thereof, and the maleic modified rosin or resin is a maleic modified rosin or resin ester or ester salt.

38. The method of claim 36, further admixing a water soluble solvent.

39. The method of claim 38, wherein the water soluble solvent is water present in about 25% to about 75% by weight of the composition.

40. The method of claim 39, further admixing a pyrrolidone in the range of about 1 to about 5 wt. % of the composition.

41. The method of claim 37, wherein the maleic modified rosin or resin is a maleic modified rosin ester salt and the fumaric modified rosin or resin is a fumaric modified rosin ester salt.

42. The method of claim 41, wherein the salts are ammonium salts.

43. The method of claim 39, further admixing about 5% to about 12% by weight of a solution of about 28% to about 30% by weight of ammonia.

44. The method of claim 41, wherein the fumaric modified rosin ester salt is a salt of a fumaric modified ester of tall oil rosin.

45. The method of claim 36, further admixing a colorant.

46. The method of claim 36, wherein the modified rosins or resins are complexed with cation to form salts.

47. The method of claim 46, wherein the cation is selected from the group consisting of amines, ammonium ions and alkyl ammonium ions.

48. The method of claim 38, further admixing an organic solvent.

49. The method of claim 48, wherein the organic solvent is anhydrous alcohol present in about 5% to about 12% by weight of the composition.

50. The method of claim 43, further admixing a base present in about 1% to about 12% by weight of the composition.

51. The method of claim 50, wherein the base is selected from the group consisting of water-soluble amines, and alkali and alkali earth metal hydroxides.

52. The method of claim 51, wherein the base is dimethylethanolamine.
